(19) United States
(12) Patent Application Publication
(10) Pub. No.: US 2019/0265516 A1
(43) Pub. Date: Aug. 29, 2019

(54) EYEGLASSES STRUCTURE

(71) Applicant: HSIEN CHANG OPTICAL INDUSTRIAL CO., LTD., Tainan (TW)

(72) Inventor: WEN-HSIUNG CHOU, TAINAN (TW)

(21) Appl. No.: 15/904,760

(22) Filed: Feb. 26, 2018

(51) Int. Cl. G02C 11/00; G02C 5/14

(52) U.S. Cl. CPC G02C 11/12; G02C 2200/04; G02C 5/146

(57) ABSTRACT

An improved eyeglasses structure is disclosed herein. It comprises a pair of temples pivotally connected to two lateral ends of a frame, wherein one side of each of the pair of temples is provided with a receiving slot at a bottom thereof and an engaging hole on an inner side thereof; and two shield pieces, each having an inserting part at an upper end thereof for correspondingly inserting into the receiving slot and an engaging part in the inserting part for correspondingly engaging with the engaging hole, wherein the two shield pieces are detachably disposed between the pair of temples and the frame.

### BACKGROUND OF THE INVENTION

### 1. Field of the Invention

The present invention relates to provide an improved eyeglasses structure which comprises two shield pieces for easily and quickly assembling or disassembling a pair of temples from a frame without damaging the original aesthetic appearance of the temples and according to a user's demand so as to protect the eyes, prevent intrusive object from damaging the eyes, and achieve increased convenience in use and practicality of overall implementation.

### 2. Description of Related Art

Generally, various eyeglasses can be classified according to different specific purposes and functions, e.g. myopia glasses, presbyopic glasses, sunglasses for protecting the eyes from sunshine or for matching the dress up, and safety glasses for eye protection during work. No matter what kind of eyeglasses, it mainly comprises a frame, lenses disposed and fixed in the frame, and a pair of temples screwed to two sides of the frame so that a user can wear the eyeglasses by the pair of temples.

The lenses of the safety glasses for eye protection during work usually does not have diopter, so people who need eyesight correction may have poor eyesight when they directly and merely wear the safety glasses. Besides, optical glasses does not have any shielding design on two laterals of the frame, so a user's eyes are prone to hurt by intrusive object during work. Although simultaneously wearing a pair of optical glasses and a pair of safety glasses can achieve effects of eyesight correction and eye protection, the user usually feels a heavy burden and discomfort, so it still needs to be improved in the overall structural design of the conventional optical glasses or safety glasses.

### SUMMARY OF THE INVENTION

In view of the above-mentioned problems, the object of the present invention is to provide an improved eyeglasses structure which comprises two shield pieces for easily and quickly assembling or disassembling a pair of temples from a frame without damaging the original aesthetic appearance of the temples and according to a user's demand so as to protect the eyes, prevent intrusive object from damaging the eyes, and achieve increased convenience in use and practicality of overall implementation.

Disclosed herein is an improved eyeglasses structure. It mainly comprises a frame having two lens assembly holes for assembling lenses; a pair of temples pivotally connected to two lateral ends of the frame, wherein one side of each of the pair of temples is provided with a receiving slot at a bottom thereof and an engaging hole on an inner side thereof; and two shield pieces, each having an inserting part at an upper end thereof for correspondingly inserting into the receiving slot of each of the pair of temples and an engaging part in the inserting part for correspondingly engaging with the engaging hole, wherein the two shield pieces are detachably disposed between the pair of temples and the frame.

According to an embodiment of the present invention, two shield pieces tightly contact an outside of the frame.

### BRIEF DESCRIPTION OF THE DRAWINGS

FIG. 1 is a first perspective view showing an improved eyeglasses structure according to the present invention;

FIG. 2 is a second perspective view showing an improved eyeglasses structure according to the present invention;

FIG. 3 is a partial exploded view showing each of two shield pieces has an inserting part for correspondingly inserting into a receiving slot of each of a pair of temples;

FIG. 4 is a partial cross-sectional view showing each of two shield pieces has an inserting part for correspondingly inserting into a receiving slot of each of a pair of temples and an engaging part in the inserting part for correspondingly engaging with an engaging hole;

FIG. 5 is a first stereogram showing an improved eyeglasses structure in assembly according to the present invention;

FIG. 6 is a second stereogram showing an improved eyeglasses structure in assembly according to the present invention;

FIG. 7 is a lateral view showing an improved eyeglasses structure in assembly according to the present invention;

FIG. 8 is a cross-sectional view showing a back of an improved eyeglasses structure in assembly according to the present invention.

### DETAILED DESCRIPTION OF THE PREFERRED EMBODIMENT

Hereinafter, an exemplary embodiment of the present invention will be described in detail with reference to the accompanying drawings.

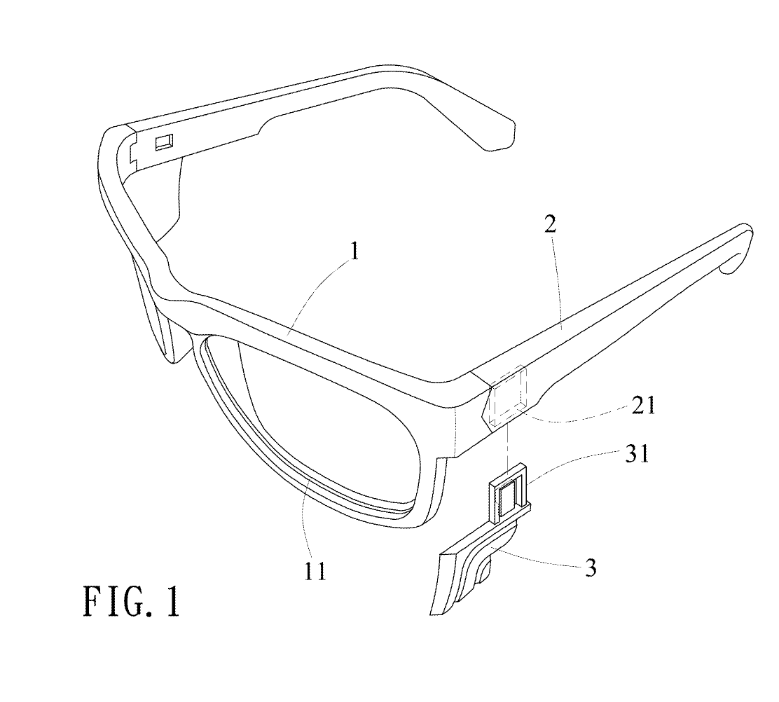

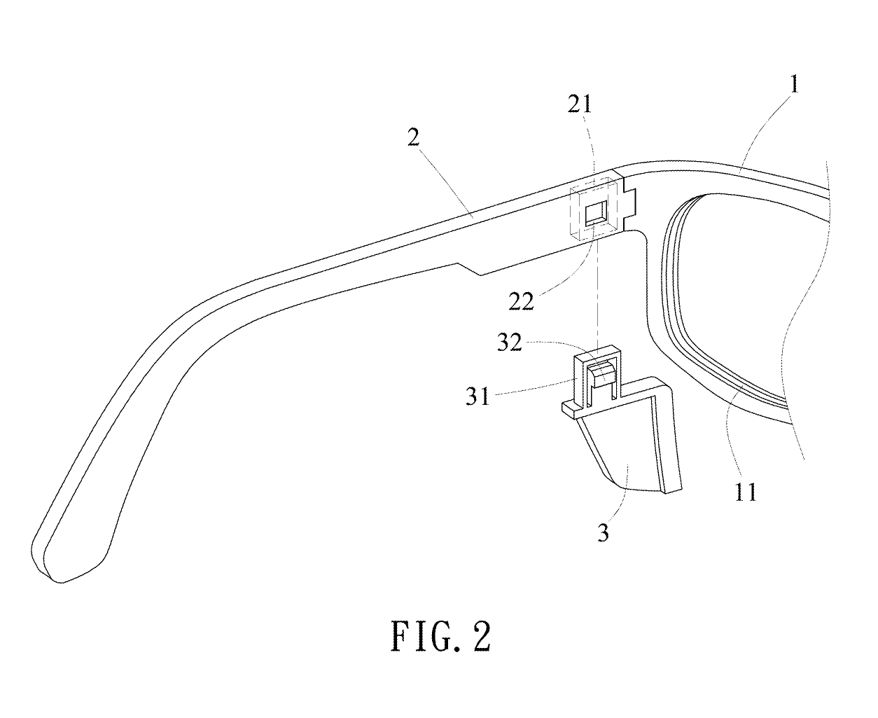

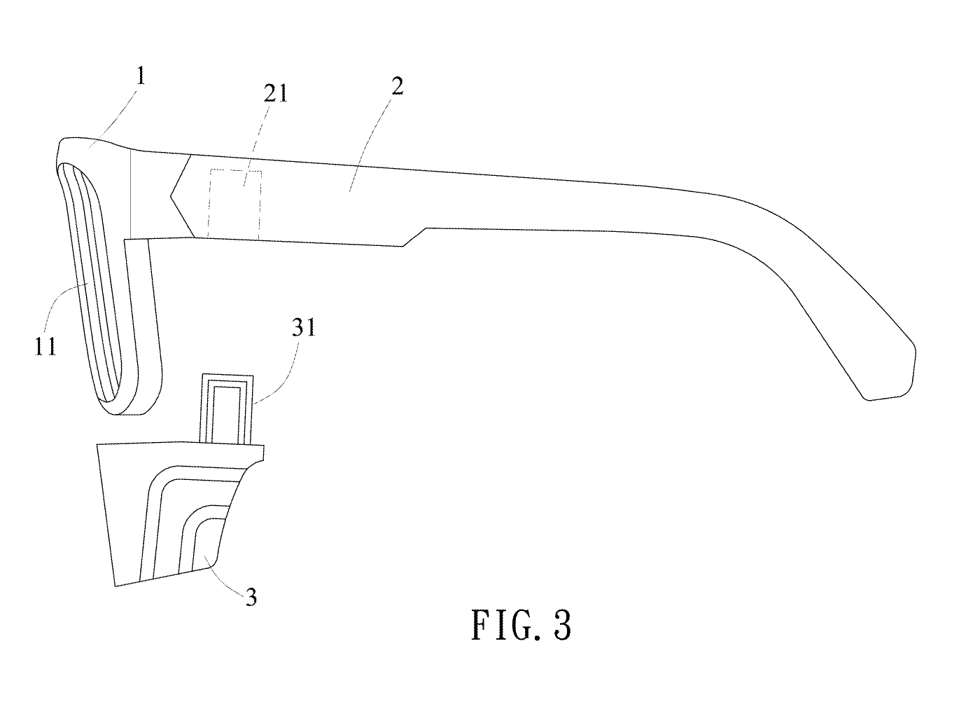

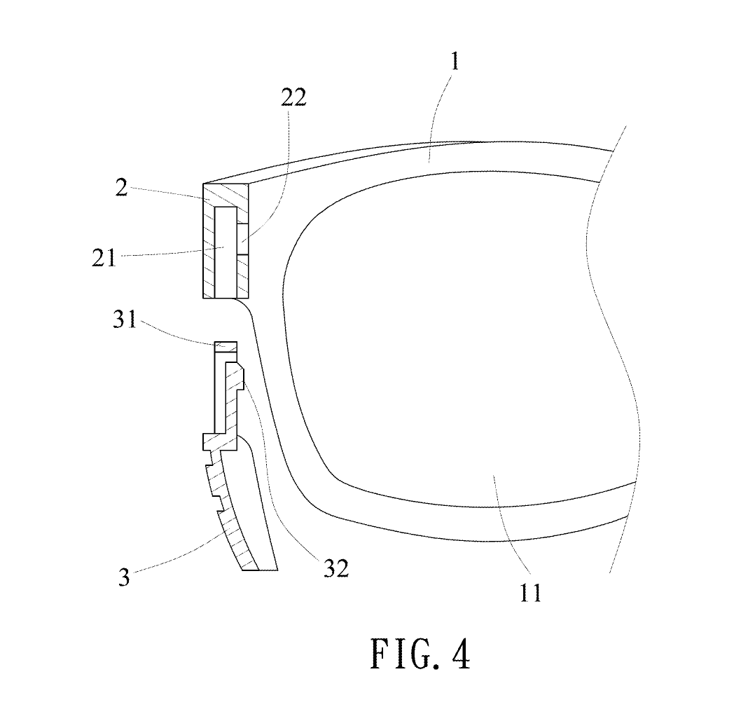

As showed in FIG. 1, FIG. 2, FIG. 3 and FIG. 4, an improved eyeglasses structure of the present invention mainly comprises a frame (1), a pair of temples (2), and two shield pieces (3) detachably disposed between the pair of temples (2) and the frame (1).

The frame (1) has two lens assembly holes (11) for assembling lenses. The pair of temples (2) are pivotally connected to two lateral ends of the frame (1), and one side of each of the pair of temples (2) is provided with a receiving slot (21) at a bottom thereof and an engaging hole (22) on an inner side thereof. An upper end thereof each of the two shield pieces (3) is provided with an inserting part (31) for correspondingly inserting into the receiving slot (21) of each of the pair of temples (2), and an engaging part (32) is provided in the inserting part (31) for correspondingly and detachably engaging with the engaging hole (22).

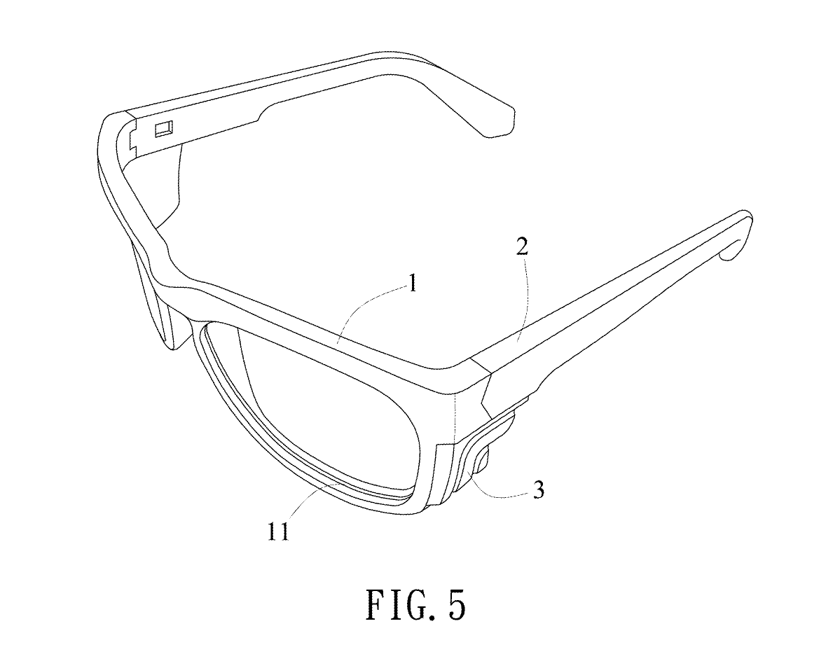

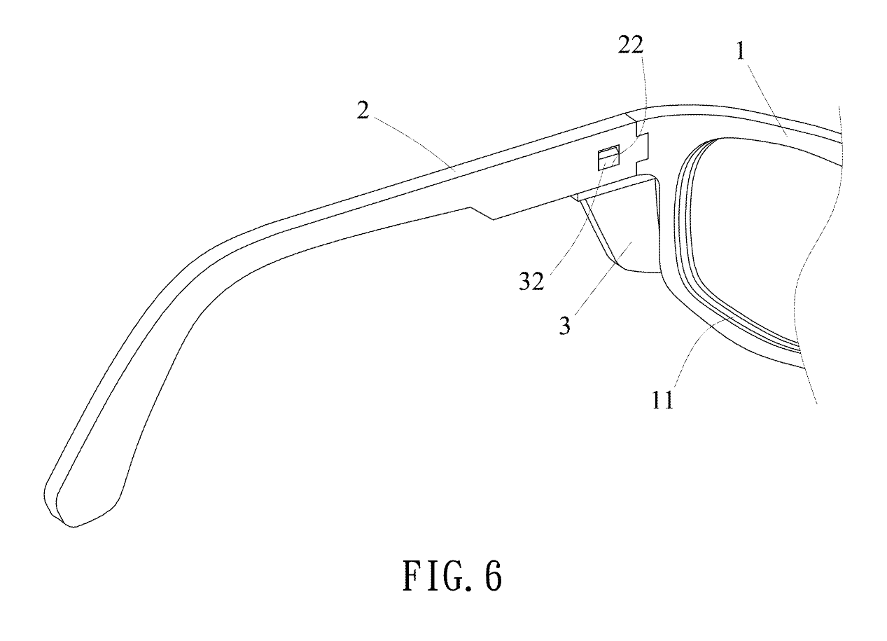

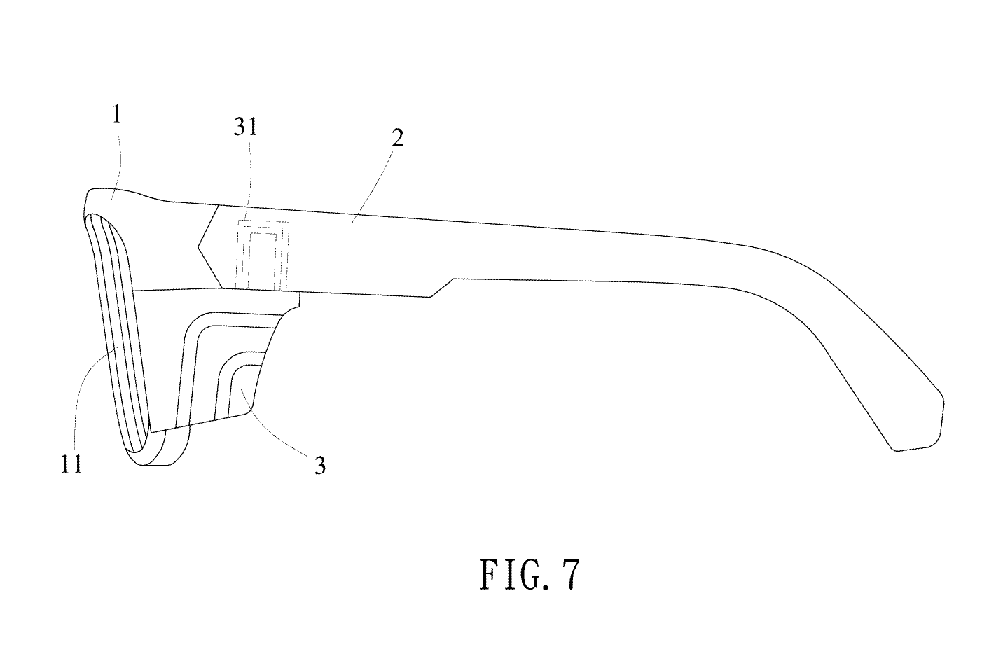

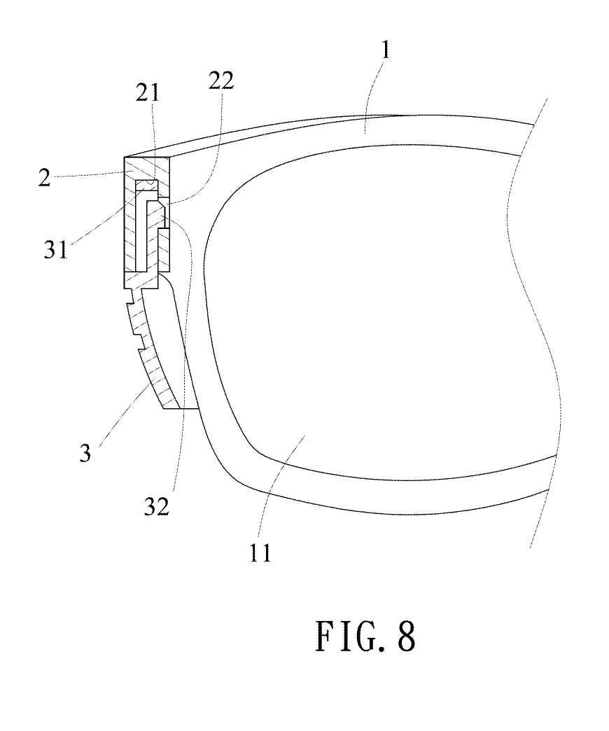

Referring to FIG. 5, FIG. 6, FIG. 7 and FIG. 8, an improved eyeglasses structure in assembly according to the present invention is disclosed. The inserting part (31) of each of the two shield pieces (3) is inserted into the receiving slot (21) of each of the pair of temples (2). In such a case, the engaging part (32) in the inserting part (31) is engaged with the engaging hole (22) for fixation, and the two shield pieces (3) are thus detachably disposed between the pair of temples (2) and the frame (1), allowing the two shield pieces (3) to tightly contact an outside of the frame (1). Accordingly, the two shield pieces (3) can prevent a user's eyes from damage by an intrusive object. If the user want to take off the two shield pieces (3) on the pair of temples (2), he or she can detach the engaging parts (32) from the engaging holes (22) by inwardly pressing the engaging parts (32). In such a case, the two shield pieces (3) can be pulled downwards to separate the inserting parts (31) from the receiving slots (21) and thus disassemble the two shield pieces (3) from the pair of temples (2).

Compared with the technique available now, the present invention has the following advantages:

1. The present invention has two shield pieces for easily and quickly assembling or disassembling a pair of temples from a frame without damaging the original aesthetic appearance of the temples.

2. The present invention having two shield pieces can be used to protect the eyes and prevent intrusive object from damaging the eyes when a user is at work, and the two shield pieces can be separated from a pair of temples according to the user's demand, so the present invention achieves increased convenience in use and practicality of overall implementation.

What is claimed is:

1. An improved eyeglasses structure, comprising:
a frame having two lens assembly holes for assembling lenses;
a pair of temples pivotally connected to two lateral ends of the frame, wherein one side of each of the pair of temples is provided with a receiving slot at a bottom thereof and an engaging hole on an inner side thereof; and
two shield pieces, each having an inserting part at an upper end thereof for correspondingly inserting into the receiving slot of each of the pair of temples and an engaging part in the inserting part for correspondingly engaging with the engaging hole, wherein the two shield pieces are detachably disposed between the pair of temples and the frame.

2. The improved eyeglasses structure as claimed, in claim 1, wherein the two shield pieces tightly contact an outside of the frame.
